(19) United States
(12) Patent Application Publication
(10) Pub. No.: US 2025/0026232 A1
(43) Pub. Date: Jan. 23, 2025

(54) CHARGING SYSTEM AND VEHICLE

(71) Applicant: SUBARU CORPORATION, Tokyo (JP)

(72) Inventor: Kazu HAMADA, Tokyo (JP)

(21) Appl. No.: 18/906,304

(22) Filed: Oct. 4, 2024

Related U.S. Application Data
(63) Continuation of application No. PCT/JP2023/025040, filed on Jul. 5, 2023.

(51) Int. Cl. B60L 53/66; B60L 53/68

(52) U.S. Cl. CPC B60L 53/66; B60L 53/68; B60L 2240/72

(57) ABSTRACT

A charging system includes a controller, and an in-vehicle device, a notification unit, an operation unit, and a wireless communication unit that are provided in the vehicle. The controller includes a processor, and a memory connected to the processor. The processor executes processing including identifying a charging station at which the vehicle is scheduled to perform charging, deriving a charging time required for the charging before the vehicle arrives at the charging station, deriving an update time required for update of a control program of the in-vehicle device through the wireless communication unit before the vehicle arrives at the charging station, making a notification of the control program as an update target through the notification unit when the update time is equal to or less than the charging time, and updating the control program when the operation unit receives an operation of permitting the update of the control program.

### CROSS-REFERENCE TO RELATED APPLICATIONS

This application is continuation of International Application No. PCT/JP2023/025040, filed on Jul. 5, 2023, the entire contents of which are hereby incorporated by reference.

### BACKGROUND

The disclosure relates to a charging system that performs charging, and a vehicle.

For example, Japanese Unexamined Patent Application Publication (JP-A) No. 2011-13893 discloses a technique of predicting the possibility that a vehicle will be charged at a charging station. In JP-A No. 2011-13893, the lower the remaining battery level of the vehicle is, the higher the charging possibility is predicted to be, and the higher the remaining battery level is, the lower the charging possibility is predicted to be.

### SUMMARY

An aspect of the disclosure provides a charging system including a controller, an in-vehicle device, a notification unit, an operation unit, and a wireless communication unit. The in-vehicle device is provided in a vehicle. The notification unit is provided in the vehicle. The operation unit is provided in the vehicle. The wireless communication unit is provided in the vehicle. The controller includes a processor, and a memory. The memory is connected to the processor. The processor is configured to execute processing including identifying a charging station at which the vehicle is scheduled to perform charging. The processor is configured to execute the processing including deriving a charging time required for the charging of the vehicle before the vehicle arrives at the charging station. The processor is configured to execute the processing including deriving an update time required for update of a control program of the in-vehicle device through the wireless communication unit before the vehicle arrives at the charging station. The processor is configured to execute the processing including making a notification of the control program as an update target through the notification unit when the update time is equal to or less than the charging time. The processor is configured to execute the processing including updating the control program when the operation unit receives an operation of permitting the update of the control program.

An aspect of the disclosure provides a vehicle including a controller, an in-vehicle device, a notification unit, an operation unit, and a wireless communication unit. The notification unit is configured to make a notification of information. The operation unit is configured to receive an operation. The wireless communication unit is configured to be able to execute wireless communication. The controller includes a processor, and a memory. The memory is connected to the processor. The processor executes processing including deriving a charging time required for charging of the vehicle, deriving an update time required for update of a control program of the in-vehicle device through the wireless communication unit, making a notification of the control program as an update target through the notification unit when the update time is equal to or less than the charging time, and updating the control program when the operation unit receives an operation of permitting the update of the control program.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a diagram illustrating an overview of a charging system according to an embodiment;

FIG. 2 is a block diagram illustrating an example of configurations of a vehicle, a charging station, and a server device constituting the charging system;

FIG. 3 is an explanatory diagram presenting information held in a memory of the server device;

FIG. 4 is an explanatory diagram presenting information held in the memory of the server device;

FIG. 5 is an explanatory diagram presenting information held in a memory of the vehicle;

FIG. 6 is a diagram illustrating an example of a display screen of a navigation device in the vehicle;

FIG. 7 is a diagram illustrating another example of a display screen of the navigation device in the vehicle; and

FIG. 8 is a flowchart presenting a flow of a charging method of the vehicle in the charging system.

### DETAILED DESCRIPTION

For a vehicle such as an electric vehicle including an electric motor as a drive source, an in-vehicle battery may be charged at a charging station. At this time, the movement of the vehicle is restricted until the charging is completed, and time is wasted. Thus, it is desirable to effectively use the waiting time during which the movement of the vehicle is restricted.

It is desirable to provide a charging system and a vehicle capable of effectively using a waiting time of charging of the vehicle.

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description. Charging System 1

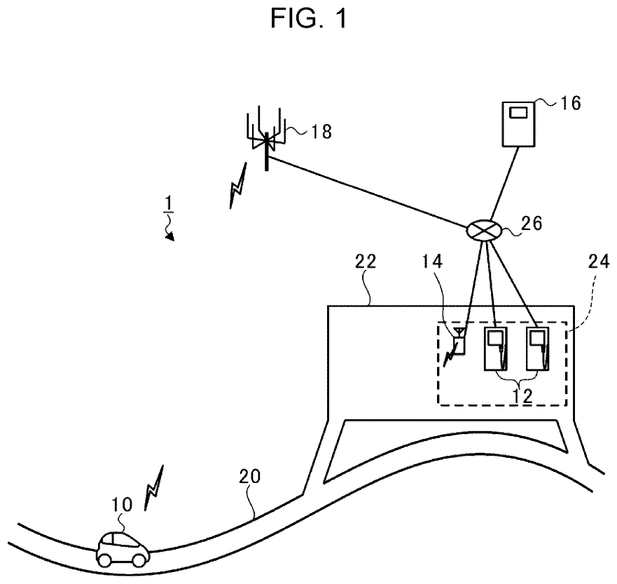

FIG. 1 is a diagram illustrating an overview of a charging system 1 according to an embodiment. The charging system 1 includes a vehicle 10, a charging station 12, a wireless communication device 14, a server device 16, and a base station 18. The vehicle 10 is an electric vehicle including an in-vehicle battery that supplies electric power to a drive source. The vehicle 10 may be a hybrid electric vehicle.

As will be described in detail later, the charging station 12 is configured to be able to charge the in-vehicle battery of the vehicle 10. Hereinafter, charging of the in-vehicle battery may be simply referred to as charging. An expression such as charging of the vehicle 10 therefore refers to charging of the in-vehicle battery of the vehicle 10.

The charging station 12 is installed, for example, in association with a predetermined position on a travel road 20. In FIG. 1, an example is given in which the charging station 12 is installed in a rest area 22 on an expressway as the travel road 20. The expressway is exemplified as the travel road 20, but the travel road 20 is not limited to such a case, and can be applied to various roads on which the vehicle 10 can travel.

An example is given in which two charging stations 12 are installed in the rest area 22, but the number of charging stations 12 is not limited to two, and may be one, or three or more. An area in which the charging stations 12 are installed and the vehicle 10 is permitted to enter for the purpose of charging is referred to as a charging area 24.

The wireless communication device 14 is installed in the vicinity of the charging stations 12, and is installed so as to be able to make wireless communication with at least the vehicle 10 located within the charging area 24. The wireless communication device 14 communicates with the vehicle 10 through, for example, a wireless local area network (LAN), for example, wireless fidelity (Wi-Fi, registered trademark) conforming to the IEEE 802.11 communication standard. Although the communication available distances of wireless LANs are as short as 15 m to 100 m, the wireless LANs can transfer a large volume of broadband data, for example, with 54 Mbps to 1.3 Gbps. However, the wireless communication system used by the wireless communication device 14 is not limited to the wireless LAN, and various existing wireless communication systems such as Bluetooth and ZigBee may be used.

The server device 16 is, for example, a cloud server, and can manage multiple charging stations 12.

The base station 18 communicates with the vehicle 10 through, for example, a mobile communication system in 4th generation (4G), 5th generation (5G), or the like. The base station 18 is connected to the vehicle 10 via wireless communication. Thus, as the wireless communication system, for example, a communication system such as an intelligent transport system (ITS), an electronic toll collection (ETC) system, or Vehicle Information and Communication System (VICS) (registered trademark) can be employed.

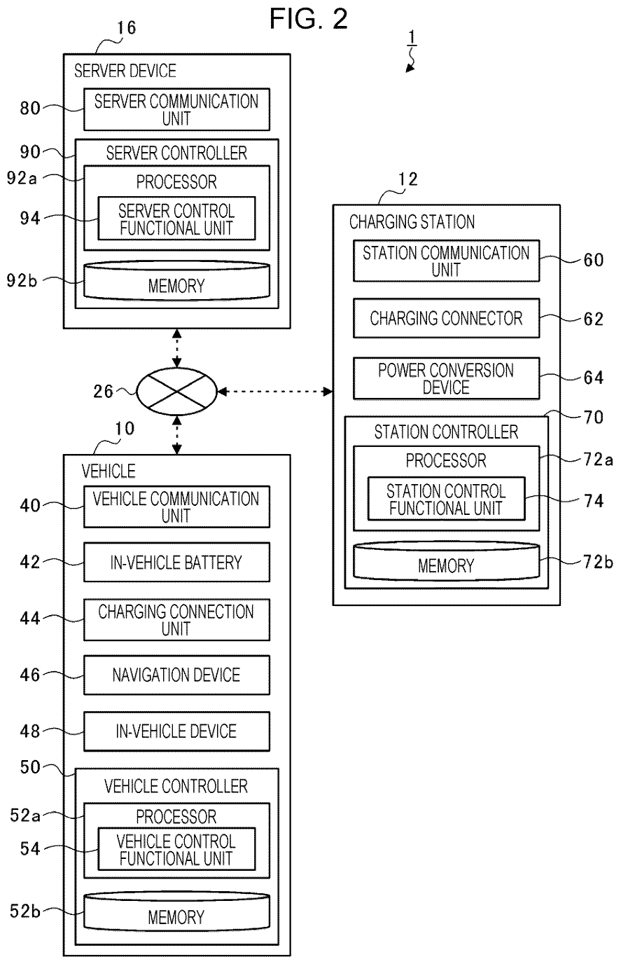

FIG. 2 is a block diagram illustrating an example of configurations of the vehicle 10, the charging station 12, and the server device 16 constituting the charging system 1. The vehicle 10, the charging station 12, and the server device 16 are configured to be able to communicate with each other through, for example, a communication network 26.

The vehicle 10 includes a vehicle communication unit 40, an in-vehicle battery 42, a charging connection unit 44, a navigation device 46, an in-vehicle device 48, and a vehicle controller 50. The vehicle communication unit 40 can establish communication with the charging station 12 and the server device 16 through the communication network 26. In one embodiment of the disclosure, the vehicle communication unit 40 serves as a wireless communication unit that transfers a control program which will be described later.

The in-vehicle battery 42 is, for example, a chargeable and dischargeable secondary battery such as a lithium-ion battery. The charging connection unit 44 has a charging port that is exposed to the outside, and is configured such that a charging connector 62 of the charging station 12, which will be described later, can be connected to the charging connection unit 44. In one embodiment of the disclosure, the charging connection unit 44 serves as a connection unit that electrically connects the charging station 12 and the in-vehicle battery 42.

The navigation device 46 can identify the position of the vehicle using the global positioning system (GPS). The navigation device 46 includes a display device capable of displaying various types of information such as map information, a travel route, and the position of the vehicle. The map information may include information on the travel road 20 and information on the installation position of the charging station 12.

In one embodiment of the disclosure, the navigation device 46 also serves as a notification unit that notifies an occupant of information related to the vehicle 10, and an operation unit that receives an operation of the occupant. For example, the navigation device 46 can display information related to charging of the vehicle 10 and information related to update of a control program on the display device in addition to or instead of the various types of information described above. The navigation device 46 can also receive an operation input of the occupant for an option related to charging of the vehicle 10 and an option related to update of the control program, for example, through a touch panel or the like provided in the navigation device 46.

The in-vehicle device 48 indicates all devices required for the vehicle 10 to travel. Each in-vehicle device 48 includes a controller and operates in accordance with a control program corresponding to the controller. Such a control program can be updated over the air (OTA). OTA refers to transmitting and receiving data via wireless communication. Processing of updating the control program by OTA may be simply referred to as update of the control program.

The vehicle controller 50 includes one or more processors 52a and one or more memories 52b connected to the one or more processors 52a. The memory 52b includes a read-only memory (ROM) in which a program and the like are stored and a random-access memory (RAM) as a work area. The processor 52a controls the entire vehicle 10 in cooperation with the program included in the memory 52b. In one embodiment of the disclosure, the processor 52a also serves as a vehicle control functional unit 54 by executing the program. The vehicle control functional unit 54 executes various types of processing related to charging of the vehicle 10 and update of the control program.

The charging station 12 includes a station communication unit 60, a charging connector 62, a power conversion device 64, and a station controller 70. The station communication unit 60 can establish communication with the server device 16 and the vehicle 10 through the communication network 26.

The charging connector 62 is configured to be connectable to the charging connection unit 44 of the vehicle 10. For example, the power conversion device 64 converts electric power of a commercial power supply and supplies the electric power to the vehicle 10 through the charging connector 62 and the charging connection unit 44. In this way, the in-vehicle battery 42 can be charged.

The station controller 70 includes one or more processors 72a and one or more memories 72b connected to the one or more processors 72a. The memory 72b includes a ROM in which a program and the like are stored and a RAM as a work area. The processor 72a controls the entire charging station 12 in cooperation with the program included in the memory 72b. In one embodiment of the disclosure, the processor 72a also serves as a station control functional unit 74 by executing the program. The station control functional unit 74 transmits various pieces of information such as a charging specification of the charging station 12 to the server device 16.

The server device 16 includes a server communication unit 80 and a server controller 90. The server communication unit 80 can establish communication with the charging station 12 and the vehicle 10 through the communication network 26.

The server controller 90 includes one or more processors 92a and one or more memories 92b connected to the one or more processors 92a. The memory 92b includes a ROM in which a program and the like are stored and a RAM as a work area. The processor 92a controls the entire server device 16 in cooperation with the program included in the memory 92b. In one embodiment of the disclosure, the processor 92a also serves as a server control functional unit 94 by executing the program. The server control functional unit 94 executes various types of processing related to charging of the vehicle 10 and update of the control program.

Such a vehicle 10 including the electric motor as the drive source tries to charge the in-vehicle battery 42 at the charging station 12 as the state of charge (SOC) of the in-vehicle battery 42 decreases. For example, when the vehicle 10 is traveling on the travel road 20, the vehicle 10 may stop at the rest area 22 and charge the in-vehicle battery 42 at the charging station 12 in the rest area 22.

However, the movement of the vehicle 10 is restricted during the waiting time until the charging of the in-vehicle battery 42 is completed, and thus the vehicle 10 wastes time. Thus, the control program of the in-vehicle device 48 of the vehicle 10 is updated by OTA using the waiting time of charging of the vehicle 10. In this way, the waiting time during which the movement of the vehicle 10 is restricted can be effectively used.

However, since the update of the control program by OTA uses wireless communication in which the communication speed (the volume of data that can be transferred per unit time) varies, the time required for the update of the control program is not determined. Thus, it may take a long time to update the control program beyond the waiting time of charging. Then, the movement of the vehicle 10 is restricted for a time equal to or more than the waiting time of charging. In a state in which the wireless communication is not stable, OTA is interrupted in the middle, and it may fail to update the control program, or the control program may be required to be updated again from the beginning.

Thus, in the embodiment, the control program of the in-vehicle device 48 of the vehicle 10 is stably updated by OTA while the restriction of the movement of the vehicle 10 for a long time is avoided.

As a premise of the processing of the embodiment, the memory 92b of the server device 16 and the memory 52b of the vehicle 10 hold various pieces of information.

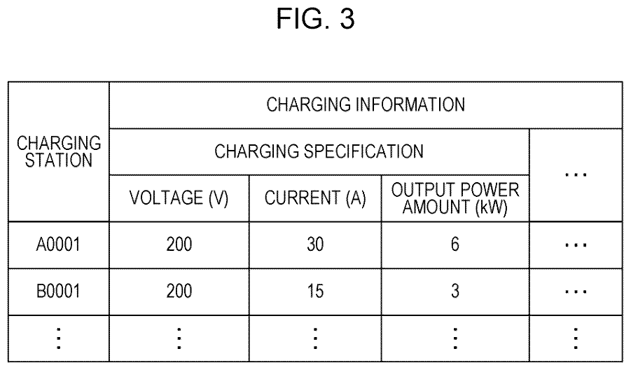

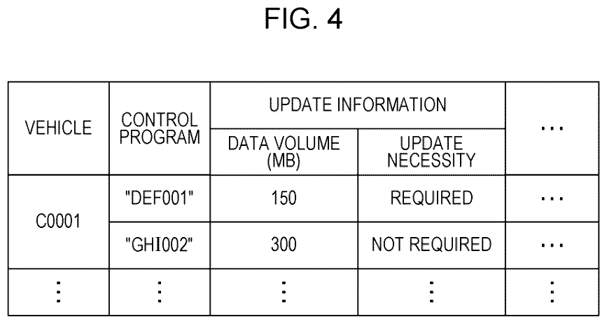

FIGS. 3 and 4 are explanatory diagrams presenting information held in the memory 92b of the server device 16. For example, as presented in FIG. 3, the memory 92b holds a table in which charging information is associated with each of multiple charging stations 12. The charging information includes various pieces of information for deriving a charging time required for charging of the vehicle 10 at a predetermined charging station 12. The charging information includes, for example, a charging specification of the charging station 12. The server control functional unit 94 of the server device 16 acquires the charging specification and the like from each charging station 12, and holds the charging specification and the like in the memory 92b in association with the charging station 12.

As presented in FIG. 4, the memory 92b of the server device 16 also holds a table in which a control program of the in-vehicle device 48 and update information corresponding to update of the control program are associated with each of multiple vehicles 10. The update information includes various pieces of information for deriving an update time required for update of a control program of a predetermined in-vehicle device 48. The update information includes, for example, the data volume of the control program. The update information also includes, for example, update necessity information indicating whether the control program is required to be updated. The server control functional unit 94 of the server device 16 acquires the data volume of the control program, the update necessity information, and the like from the manufacturer of the vehicle 10, and holds the data volume of the control program, the update necessity information, and the like in the memory 92b in association with the vehicle 10.

An example is described in which charging information, a control program, and update information are held in the memory 92b of one server device 16, but the example does not imply any limitation, and charging information, a control program, and update information may be held in memories 92b of different server devices 16.

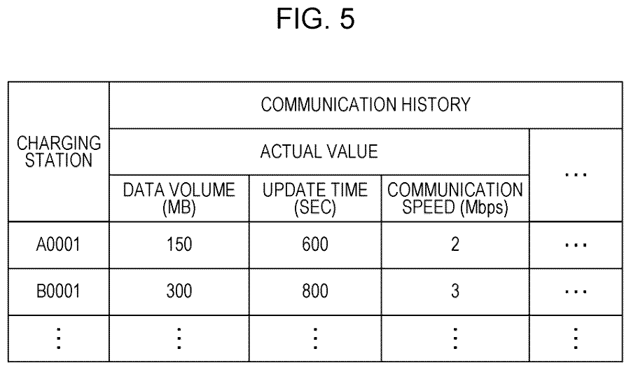

FIG. 5 is an explanatory diagram presenting information held in the memory 52b of the vehicle 10. For example, as presented in FIG. 5, the memory 52b holds a table in which a communication history is associated with each of wireless communication devices 14 corresponding to multiple charging stations 12. The communication history includes various pieces of information for deriving a communication speed in wireless communication between a vehicle 10 and a wireless communication device 14 corresponding to a predetermined charging station 12. The communication history includes, for example, actual values of a data volume, an update time, and a communication speed when wireless communication was executed in the past. Each time the control program is updated, the vehicle control functional unit 54 of the vehicle 10 measures the data volume and the update time, and stores the data volume, the update time, and the communication speed in the memory 92b in association with the charging station 12.

In the embodiment, first, it is determined whether it is necessary to update a control program. The vehicle control functional unit 54 of the vehicle 10 establishes communication with the server device 16 via the base station 18 at the time when the vehicle 10 is brought into an ignition-ON state or a ready-ON state, and requests acquisition of update necessity information. The server control functional unit 94 of the server device 16 transmits the update necessity information to the vehicle 10. The vehicle control functional unit 54 determines whether there is a control program required to be updated based on the update necessity information.

When there is no control program required to be updated, the vehicle control functional unit 54 does not perform the processing related to update of the control program until the vehicle 10 is brought into the ignition—ON state or the ready—ON state next time. In contrast, when there is a control program required to be updated, the vehicle control functional unit 54 updates the control program of the in-vehicle device 48 by OTA using the waiting time of charging of the vehicle 10. Hereinafter, an operation of the charging system 1 will be described on a premise that there is a control program required to be updated.

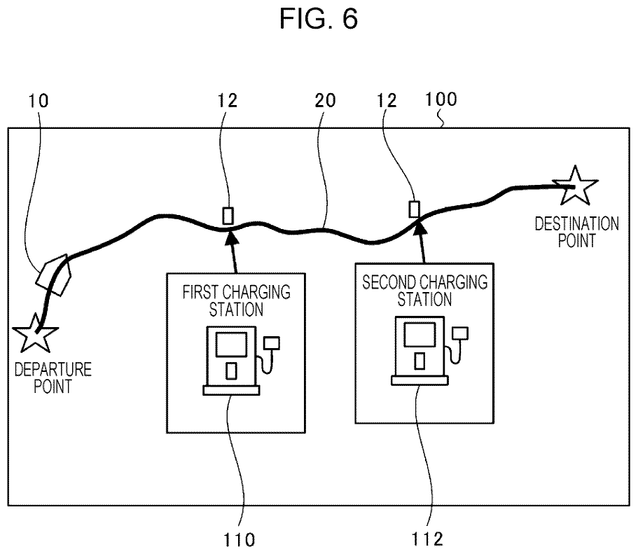

FIG. 6 is a diagram illustrating an example of a display screen 100 of the navigation device 46 in the vehicle 10. When the SOC of the in-vehicle battery 42 decreases, the occupant of the vehicle 10 identifies a charging station 12 available for charging on a travel road 20. The navigation device 46 displays a departure point, a destination point, the travel road 20, and the current position of the vehicle 10. The navigation device 46 displays, for example, an image indicating the position of a first charging station 110 and an image indicating the position of a second charging station 112 that are charging stations 12 at which the vehicle 10 can reach with the current SOC. The occupant identifies, for example, the first charging station 110 among the charging stations 12 at which charging is desired from the displayed charging stations 12 through the navigation device 46.

Since the purpose is to identify the charging time, the vehicle control functional unit 54 may identify the charging station 12 at which charging is desired. However, without being limited to such a case, the vehicle control functional unit 54 may establish communication with the charging station 12 via the base station 18 and reserve charging for a predetermined time at the identified charging station 12. When such a charging reservation is made, charging during the reservation time is assured at the charging station 12.

The vehicle control functional unit 54 establishes communication with the server device 16 via the base station 18, and requests acquisition of charging information corresponding to the identified charging station 12. The server control functional unit 94 of the server device 16 transmits the charging information to the vehicle 10. In a state in which the vehicle 10 has not yet arrived at the charging area 24, the vehicle control functional unit 54 derives a charging time required for charging of the vehicle 10 based on the charging information as follows.

First, the vehicle control functional unit 54 derives a remaining distance d between the current position of the vehicle 10 and the charging station 12. Next, the vehicle control functional unit 54 multiplies an average power consumption (power consumption amount required per unit travel distance) Wa of the vehicle 10 by the remaining distance d to derive a power consumption amount Wu that the vehicle 10 consumes until the vehicle 10 arrives at the charging area 24. Subsequently, the vehicle control functional unit 54 subtracts the power consumption amount Wu from a current remaining power amount Wro of the in-vehicle battery 42 to derive a remaining power amount Wrn at the time when the vehicle 10 arrives at the charging area 24. Next, the vehicle control functional unit 54 derives a chargeable power amount Wp obtained by subtracting the remaining power amount Wrn at the time of arrival from a maximum power amount Wm of the in-vehicle battery 42.

The vehicle control functional unit 54 causes the occupant to identify a charging power amount Wc that is equal to or less than the chargeable power amount Wp through the navigation device 46. Subsequently, the vehicle control functional unit 54 derives a charging time by dividing the charging power amount Wc by an output power amount (chargeable power amount per unit time) Ws of the charging station 12.

Next, the vehicle control functional unit 54 acquires the data volume corresponding to the control program required to be updated from the server device 16. In a state in which the vehicle 10 has not yet arrived at the charging area 24, the vehicle control functional unit 54 derives an update time required for update of the control program based on the acquired data volume as follows.

First, the vehicle control functional unit 54 extracts, from the memory 52b, a communication speed Dv at which communication was made in the past with a wireless communication device 14 corresponding to the identified charging station 12. The communication speed Dv at which communication was made in the past with the wireless communication device 14 is directly used, but a predicted value of a communication speed that is statistically predicted from actual values for multiple times may be used.

Next, the vehicle control functional unit 54 divides the acquired data volume D by the extracted communication speed Dv to derive a communication time Tc. Subsequently, the vehicle control functional unit 54 derives a reflection time Tr of the control program to the in-vehicle device 48 including a downloading time of the control program to the in-vehicle device 48 and a rewriting time of the control program in the in-vehicle device 48. Next, the vehicle control functional unit 54 adds the communication time Tc and the reflection time Tr, and multiplies the sum by, for example, 1.2 as a margin coefficient to derive an update time. The margin coefficient is a margin for accommodating a variation in the communication state of wireless communication.

With such a configuration, it is possible to use the past actual value with the variation in the communication state reflected for identifying the update time, and thus it is possible to improve the accuracy of identifying the update time.

An example is described in which the vehicle control functional unit 54 refers to a communication history of the wireless communication device 14 corresponding to the identified charging station 12. However, without being limited to such a case, another example is conceivable as long as equivalent wireless communication is made. That is, the vehicle control functional unit 54 can refer to the communication history of the wireless communication device 14 that has executed communication in the past as long as the wireless communication device 14 can be determined as being capable of making wireless communication equivalently to the wireless communication device 14 that has executed communication in the past regardless of which charging station 12 the wireless communication device 14 executes communication with.

When the charging time and the update time are identified, the vehicle control functional unit 54 compares the update time with the charging time. When the update time is equal to or less than the charging time, the vehicle control functional unit 54 determines that the control program can be updated within the waiting time of charging, and prompts the occupant to update the control program through the navigation device 46.

For example, the navigation device 46 displays the update time and an image asking whether to update the control program. The update of the control program does not necessarily end within the waiting time of charging depending on the communication state, and hence a notice to that situation may also be displayed on the navigation device 46.

In response to that the vehicle control functional unit 54 receives an operation of permitting the update of the control program by the occupant through the navigation device 46, the vehicle control functional unit 54 enters a standby state for communication establishment with the wireless communication device 14 in order to update the control program.

When the vehicle 10 arrives at the charging area 24, the vehicle control functional unit 54 establishes communication with the wireless communication device 14. The vehicle control functional unit 54 acquires the control program from the server device 16 through the wireless communication device 14. Next, the vehicle control functional unit 54 updates the in-vehicle device 48 with the acquired control program.

While updating the control program, the vehicle control functional unit 54 sequentially holds the actual value of the wireless communication in the memory 52b. In this way, the vehicle 10 can construct the past communication history related to the wireless communication with the wireless communication device 14.

In parallel with this, when the vehicle 10 moves to the charging station 12, the occupant connects the charging connector 62 of the charging station 12 to the charging connection unit 44 of the vehicle 10. In this way, the charging station 12 can charge the in-vehicle battery 42 of the vehicle 10 with electric power.

The vehicle control functional unit 54 manages charging of the vehicle 10 and update of the control program. Thus, the vehicle control functional unit 54 can manage the progress state of the charging of the vehicle 10 and the progress state of the update of the control program, and can grasp the completion of the charging and the update. When the charging of the vehicle 10 is completed and the update of the control program is completed, the vehicle control functional unit 54 makes a notification of the completion through the navigation device 46.

When the update of the control program is completed but the charging of the vehicle 10 is not completed, the vehicle control functional unit 54 makes a notification that the update of the control program is completed and the remaining charging time until the charging is completed. When the charging of the vehicle 10 is completed but the update of the control program is not completed, the vehicle control functional unit 54 makes a notification that the charging is completed and the remaining update time until the update is completed.

Since the update start condition of the control program is the charging time >the update time, originally, there is no case where the update is not completed although the charging is completed. However, as described above, the communication state varies, and the update of the control program is not necessarily completed within the waiting time of charging. In this case, by making the notification of the remaining update time, it is possible to inform the occupant that it takes time to update the control program unexpectedly.

Since the past control program is deleted by the update of the control program, it is not desirable to interrupt the update of the control program in the middle. Thus, once the update of the control program is started, even though the charging is completed, the control program is not interrupted accordingly.

After the update of the control program is completed, the vehicle control functional unit 54 stores the data volume of the control program, the update time actually spent for the update, and the communication speed obtained by dividing the data volume by the update time in the memory 52b in association with the charging station 12. The vehicle control functional unit 54 uses such information as a communication history at the time of the next update of the control program.

The example has been described in which the vehicle control functional unit 54 derives the charging time and the update time in the state in which the vehicle 10 has not arrived at the charging area 24. However, when there is no communication history of past communication with the wireless communication device 14 corresponding to the identified charging station 12 in the memory 52b of the vehicle 10, the communication speed is not derived. Even when the vehicle control functional unit 54 derives the charging time and the update time in the state in which the vehicle 10 has not arrived at the charging area 24, the user may want to confirm that the communication speed is stable by actually establishing wireless communication with the wireless communication device 14 after the vehicle 10 arrives at the charging area 24.

In this case, the vehicle control functional unit 54 may derive the charging time and the update time after the vehicle 10 arrives at the charging area 24 and actually establishes wireless communication with the wireless communication device 14.

For example, after the vehicle 10 arrives at the charging area 24, the vehicle control functional unit 54 derives a chargeable power amount Wp by subtracting a remaining power amount Wrn at the time of arrival from a maximum power amount Wm of the in-vehicle battery 42. The vehicle control functional unit 54 causes the occupant to identify a charging power amount Wc that is equal to or less than the chargeable power amount Wp through the navigation device 46. Subsequently, the vehicle control functional unit 54 derives a charging time by dividing the charging power amount Wc by an output power amount Ws of the charging station 12.

The vehicle control functional unit 54 establishes communication with the server device 16 via the wireless communication device 14, and measures a communication speed Dv with the wireless communication device 14. Next, the vehicle control functional unit 54 divides a data volume D acquired from the server device 16 by the actually measured communication speed Dv to derive a communication time Tc. Subsequently, the vehicle control functional unit 54 adds the communication time Tc and the reflection time Tr, and multiplies the sum by the margin coefficient to derive an update time.

With such a configuration, the charging time and the update time can be derived in one or both of the state in which the vehicle 10 has not arrived at the charging area 24 and the state in which the vehicle 10 has established wireless communication with the wireless communication device 14. Thus, the accuracy of identifying the update time can be improved, and the control program can be updated in a stable communication state.

For convenience of description, the example has been described in which the vehicle control functional unit 54 acquires the data volume corresponding to one control program from the server device 16. However, without being limited to such a case, a data volume corresponding to multiple control programs may be acquired.

The vehicle control functional unit 54 determines whether there is a control program required to be updated based on the update necessity information. When there is a control program required to be updated, the vehicle control functional unit 54 acquires data volumes corresponding to all control programs required to be updated from the server device 16. This indicates that the control program is required to be updated for each of multiple in-vehicle devices 48 such as a brake system and a drive control system.

The vehicle control functional unit 54 divides the data volumes D corresponding to all the acquired control programs by the communication speed Dv to derive respective communication times Tc. Subsequently, the vehicle control functional unit 54 adds the communication time Tc and the reflection time Tr for each of the control programs and multiplies the sum by the margin coefficient to derive an update time for each of the control programs.

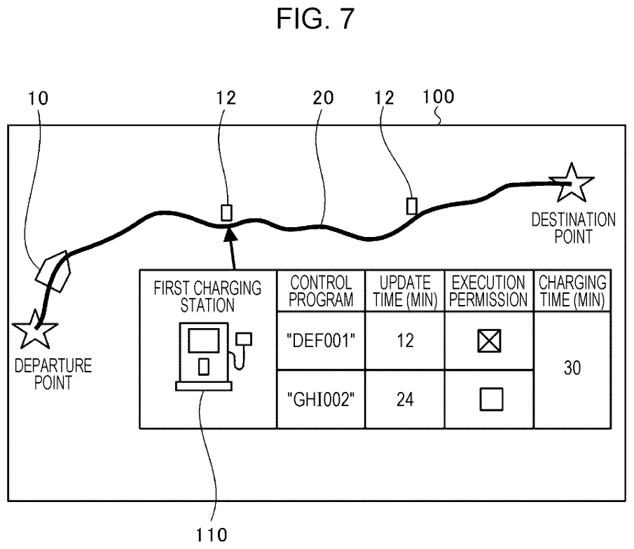

FIG. 7 is a diagram illustrating another example of a display screen 100 of the navigation device 46 in the vehicle 10. The vehicle control functional unit 54 prompts the occupant to update all the control programs of which the update times are equal to or less than the charging time through the navigation device 46. For example, as illustrated in FIG. 7, an update time and a check box indicating whether to execute update of the control program are displayed for each of all control programs “DEF001” and “GHI002” of which update times are equal to or less than 30 minutes that is the charging time on the navigation device 46. The occupant can determine the control program to be updated through the navigation device 46.

When the total of the update times of the multiple control programs is equal to or less than the charging time, the occupant can determine multiple control programs of which the total of the update times is equal to or less than the charging time through the navigation device 46. In this case, after the occupant determines one control program, the vehicle control functional unit 54 prompts the occupant to update the control program of which the update time is equal to or less than the time obtained by subtracting the update time of the determined control program from the charging time.

In response to that the vehicle control functional unit 54 receives an operation of permitting the update of the control program by the occupant through the navigation device 46, the vehicle control functional unit 54 acquires all control programs determined by the occupant from the server device 16. The vehicle control functional unit 54 updates the in-vehicle devices 48 with the acquired control programs.

With such a configuration, it is possible to update the multiple control programs of which the total of the update times is equal to or less than the charging time, and it is possible to more effectively use the waiting time during which the movement of the vehicle 10 is restricted.

The example has been described in which, in response to that the vehicle 10 has arrived at the charging area 24, it is determined whether it is necessary to update the control program, and the update of the control program is started. However, without being limited to such a case, the update of the control program may be started at an earlier timing.

As described above, the wireless LAN exemplified as the wireless communication system of the wireless communication device 14 has a short communication available distance. However, for example, in a flat area with few obstacles such as the rest area 22, communication can be made even at a relatively long distance. Thus, the vehicle control functional unit 54 establishes communication with the wireless communication device 14 inside the rest area 22 or outside the rest area 22. In response to that the vehicle control functional unit 54 receives an operation of permitting the update of the control program by the occupant, the vehicle control functional unit 54 acquires the control program from the server device 16 even before the start of charging. The vehicle control functional unit 54 updates the in-vehicle device 48 with the acquired control program.

With such a configuration, for example, since the control program can be updated before charging is started in the charging area 24, the control program can be stably updated even when the update time is extended due to a variation in the communication state.

In this case, if it takes time to start charging, the vehicle control functional unit 54 may determine whether it is necessary to update the control program when the update time is equal to or less than the charging time and when the update time is equal to or less than (the waiting time until the start of charging+the charging time).

With such a configuration, for example, when there are many vehicles desired to be charged in the charging area 24 and the waiting time until the start of charging is long, it is possible to update a control program that requires a long time for update or multiple control programs.

The example has been described in which the vehicle control functional unit 54 derives the update time using the communication speed Dv that is the past actual value held in the memory 52b. However, without being limited to such a case, the server device 16 may derive the update time using the communication speed Dv that is the past actual value.

For example, the server control functional unit 94 of the server device 16 accumulates actual values of communication speeds Dv at which multiple wireless communication devices 14 communicated in the past in the memory 92b, for example, in association with the types of vehicles 10. Thus, the memory 92b stores the past actual values for combinations of the wireless communication devices 14 and the types of vehicles 10.

In response to that the server control functional unit 94 receives a request for acquisition of the update time from the vehicle control functional unit 54, the server control functional unit 94 extracts the communication speed Dv that is the past actual value in the combination of the wireless communication device 14 and the type of the vehicle 10. Next, the server control functional unit 94 divides the data volume D by the communication speed Dv to derive the communication time Tc. Subsequently, the server control functional unit 94 transmits the communication time Tc to the vehicle 10. The vehicle control functional unit 54 adds the communication time Tc and the reflection time Tr acquired from the server device 16, and multiplies the sum by the margin coefficient to derive the update time.

In this case, after the update of the control program is completed, the vehicle control functional unit 54 transmits the update time actually spent for the update and the communication speed obtained by dividing the data volume by the update time to the server device 16. The server control functional unit 94 holds the update time and the communication speed in the memory 92b, and uses the update time and the communication speed as a communication history at the time of the next update of the control program.

With such a configuration, since an appropriate communication speed corresponding to the combination of the wireless communication device 14 and the vehicle 10 is identified, it is possible to identify the communication speed with high accuracy regardless of the variation in the communication state.

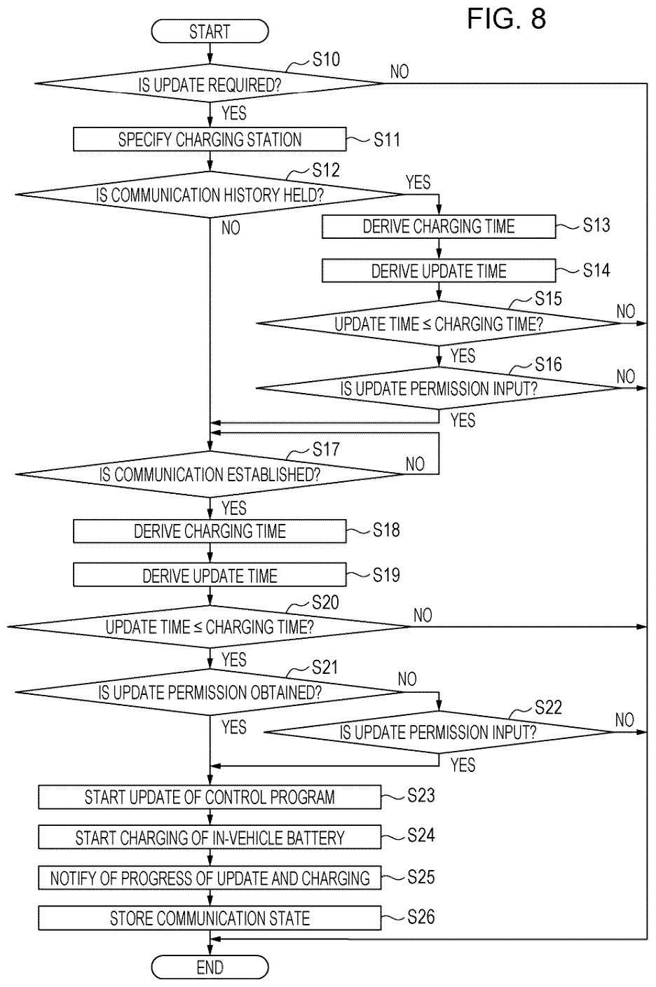

FIG. 8 is a flowchart presenting a flow of a charging method of the vehicle 10 in the charging system 1.

When the ignition of the vehicle 10 is turned ON, the vehicle control functional unit 54 establishes communication with the server device 16, and acquires update necessity information from the server device 16. Then, the vehicle control functional unit 54 determines whether there is a control program required to be updated based on the update necessity information (S10). When there is no control program required to be updated (NO in S10), the vehicle control functional unit 54 ends the charging method without updating the control program. When there is a control program required to be updated (YES in S10), the control program is updated in parallel with charging of the vehicle 10.

In order to charge the vehicle 10 as the SOC of the in-vehicle battery 42 decreases, the vehicle control functional unit 54 identifies a charging station 12 located on a travel route (S11). The vehicle control functional unit 54 determines whether a communication history of communication with the identified wireless communication device 14 or a wireless communication device 14 of the same type as the identified wireless communication device 14 is held in the memory 52b (S12). When the communication history is not held (NO in S12), the vehicle control functional unit 54 proceeds to the processing of step S17.

When the communication history is held (YES in S12), the vehicle control functional unit 54 derives a chargeable power amount Wp based on a remaining distance d, an average power consumption Wa, a remaining power amount Wro, and a maximum power amount Wm, and identifies a charging power amount Wc that is equal to or less than the chargeable power amount Wp. The vehicle control functional unit 54 derives a charging time by dividing the charging power amount Wc by an output power amount Ws of the charging station 12 (S13).

Next, the vehicle control functional unit 54 acquires a data volume D corresponding to the control program from the server device 16, and derives an update time based on the data volume D and a communication speed Dv that is a past actual value (S14). Subsequently, the vehicle control functional unit 54 compares the update time with the charging time (S15). When the update time is more than the charging time (NO in S15), the vehicle control functional unit 54 ends the charging method without updating the control program.

When the update time is equal to or less than the charging time (YES in S15), the vehicle control functional unit 54 prompts the occupant to update the control program through the navigation device 46 (S16). In response to that the vehicle control functional unit 54 receives an operation of not permitting the update of the control program by the occupant through the navigation device 46 (NO in S16), the vehicle control functional unit 54 ends the charging method without updating the control program. In response to that the vehicle control functional unit 54 receives an operation of permitting the update of the control program by the occupant (YES in S16), the vehicle control functional unit 54 proceeds to a waiting state for establishment of communication with the wireless communication device 14.

The vehicle control functional unit 54 tries to establish communication with the wireless communication device 14 (S17). Until the communication with the wireless communication device 14 is established (NO in S17), the vehicle control functional unit 54 repeats the processing of step S17. When the vehicle 10 arrives at the rest area 22 and communication with the wireless communication device 14 is established (YES in S17), the vehicle control functional unit 54 derives the chargeable power amount Wp based on a remaining power amount Wrn at that time and the maximum power amount Wm, and identifies the charging power amount Wc that is equal to or less than the chargeable power amount Wp. The vehicle control functional unit 54 derives a charging time by dividing the charging power amount Wc by the output power amount Ws of the charging station 12 (S18).

Next, the vehicle control functional unit 54 acquires the data volume D corresponding to the control program from the server device 16, and derives an update time based on the data volume D and the actual measurement value of the communication speed Dv at that time (S19). Subsequently, the vehicle control functional unit 54 compares the update time with the charging time (S20). When the update time is more than the charging time (NO in S20), the vehicle control functional unit 54 ends the charging method without updating the control program.

When the update time is equal to or less than the charging time (YES in S20), the vehicle control functional unit 54 determines in step S16 whether the permission to update the control program has already been obtained from the occupant (S21). When the permission to update the control program has already been obtained from the occupant (YES in S21), the vehicle control functional unit 54 proceeds to step S23.

When the permission to update the control program has not been obtained from the occupant (NO in S21), the vehicle control functional unit 54 prompts the occupant to update the control program through the navigation device 46 (S22). In response to that the vehicle control functional unit 54 receives an operation of not permitting the update of the control program through the navigation device 46 (NO in S22), the vehicle control functional unit 54 ends the charging method without updating the control program.

In response to that the operation of permitting the update of the control program by the occupant is received (YES in S22), or as long as the permission for updating the control program has already been obtained from the occupant in step S21 (YES in S21), the vehicle control functional unit 54 acquires the control program from the server device 16 through the wireless communication device 14, and updates the in-vehicle device 48 with the acquired control program (S23). While updating the control program, the vehicle control functional unit 54 sequentially holds the communication history in the memory 52b.

Subsequently, when the occupant connects the charging connector 62 of the charging station 12 to the charging connection unit 44 of the vehicle 10, the vehicle control functional unit 54 starts charging of the vehicle 10 (S24).

Next, the vehicle control functional unit 54 makes a notification of the progress state of the charging of the vehicle 10 and the progress state of the update of the control program through the navigation device 46 (S25). For example, when the update of the control program is completed but the charging of the vehicle 10 is not completed, the vehicle control functional unit 54 makes a notification that the update of the control program is completed and the remaining charging time until the charging is completed. In contrast, when the charging of the vehicle 10 is completed but the update of the control program is not completed, the vehicle control functional unit 54 makes a notification that the charging is completed and the remaining update time until the update is completed. When the charging of the vehicle 10 is completed and the update of the control program is completed, the vehicle control functional unit 54 makes a notification of the completion through the navigation device 46.

After the update of the control program is completed, the vehicle control functional unit 54 stores the update time actually spent for the update and the communication speed obtained by inverse operation based on the update time and the data volume in the memory 52b (S26).

In the embodiment, since the control program is updated during charging of the vehicle 10 of which the movement is restricted, it is possible to reduce a variation in the communication state between the vehicle 10 and the wireless communication device 14 and to stably update the control program by OTA. Since the past actual value with the variation in the communication state reflected is used to identify the update time, it is possible to improve the accuracy of identifying the update time. Since the control program is updated when the update time identified with high accuracy as described above is equal to or less than the charging time, it is possible to avoid a situation in which the movement of the vehicle 10 is restricted for a long time.

Although the embodiment of the disclosure has been described above with reference to the accompanying drawings, the disclosure is not limited to the embodiment. It is apparent to those skilled in the art that various changes and modifications can be made within the scope described in the claims, and it is understood that these naturally belong to the technical scope of the disclosure.

A series of processing performed by each device (for example, the vehicle 10, the server device 16) according to the embodiment described above may be implemented by using any of software, hardware, and a combination of software and hardware. A program constituting the software is stored in advance in, for example, non-transitory media provided inside or outside each device. Then, for example, the program is read from a non-transitory medium (for example, a ROM) to a transitory storage medium (for example, a RAM) and executed by a processor such as a CPU.

It is possible to create a program for implementing each function of each device described above and install the program in a computer of each device. When the processor executes the program stored in the memory, the processing of each function described above is executed. At this time, the program may be shared and executed by multiple processors, or the program may be executed by one processor. Each function of each device described above may be implemented by cloud computing using multiple computers connected to each other via a communication network. The program may be provided and installed in the computer of each device by being distributed from an external device through a communication network.

According to the embodiment of the disclosure, the waiting time of charging of the vehicle can be effectively used.

1. A charging system comprising:
a controller;
an in-vehicle device provided in a vehicle;
a notification unit provided in the vehicle;
an operation unit provided in the vehicle; and
a wireless communication unit provided in the vehicle,
wherein the controller comprises
a processor, and
a memory connected to the processor, and
wherein the processor is configured to execute processing comprising
identifying a charging station at which the vehicle is scheduled to perform charging,
deriving a charging time required for the charging of the vehicle before the vehicle arrives at the charging station,
deriving an update time required for update of a control program of the in-vehicle device through the wireless communication unit before the vehicle arrives at the charging station,
making a notification of the control program as an update target through the notification unit when the update time is equal to or less than the charging time, and
updating the control program when the operation unit receives an operation of permitting the update of the control program.

2. The charging system according to claim 1,
wherein the processor executes processing comprising
deriving the update time based on a past communication history of communication executed through the wireless communication unit.

3. The charging system according to claim 1,
wherein the control program comprises multiple programs, and
wherein the processor executes processing comprising
deriving the update time for each of the multiple control programs, and
making a notification of all control programs among the multiple control program of which the update times are equal to or less than the charging time as update targets through the notification unit.

4. The charging system according to claim 1,
wherein the processor executes processing comprising
when the update of the control program is not completed although the charging of the vehicle is completed, making a notification that the update of the control program is not completed although the charging of the vehicle is completed through the notification unit.

5. The charging system according to claim 1,
wherein the processor executes processing comprising
starting the update of the control program before the charging of the vehicle is started.

6. A vehicle comprising:
a controller;
an in-vehicle device;
a notification unit configured to make a notification of information;
an operation unit configured to receive an operation; and
a wireless communication unit configured to be able to execute wireless communication,
wherein the controller comprises
a processor, and
a memory connected to the processor, and wherein the processor executes processing comprising
deriving a charging time required for charging of the vehicle,
deriving an update time required for update of a control program of the in-vehicle device through the wireless communication unit,
making a notification of the control program as an update target through the notification unit when the update time is equal to or less than the charging time, and
updating the control program when the operation unit receives an operation of permitting the update of the control program.
